(19) United States
(12) Patent Application Publication
(10) Pub. No.: US 2019/0331324 A1
(43) Pub. Date: Oct. 31, 2019

(54) CLAMPING BRACKET FOR A DRIVER OF A LIGHTING FIXTURE

(71) Applicant: Hubbell Incorporated, Shelton, CT (US)

(72) Inventor: Adam J. Clark, Bradenton, FL (US)

(21) Appl. No.: 16/395,484

(22) Filed: Apr. 26, 2019

Related U.S. Application Data
(60) Provisional application No. 62/664,997, filed on May 1, 2018.
(60) Provisional application No. 62/663,313, filed on Apr. 27, 2018.

(51) Int. Cl. F21V 17/10; F21V 23/00

(52) U.S. Cl. CPC F21V 17/10; F21Y 2115/10; F21V 23/002; F21V 23/009

(57) ABSTRACT

A lighting fixture includes one or more drivers and a mounting surface. The lighting fixture can include a clamping bracket configured to secure the one or more drivers to the mounting surface. The clamping bracket can include a body. The clamping bracket can further include a first arm and a second arm. The first arm and the second arm can each extend from the body. Furthermore, the first arm and the second arm can each be bent relative to the body when the one or more drivers are secured to the mounting surface via the clamping bracket.

### PRIORITY CLAIM

The present application is based on and claims priority to U.S. Provisional App. No. 62/663,313, titled “Clamping Bracket for a Driver of a Lighting Fixture,” having a filing date of Apr. 27, 2018 which is incorporated by reference herein. The present application is also based on and claims priority to U.S. Provisional App. No. 62/664,997, titled “Clamping Bracket for a Driver of a Lighting Fixture,” having a filing date of May 1, 2018.

### FIELD

The present disclosure relates generally to a clamping bracket for drivers.

### BACKGROUND

Lighting fixtures (e.g., luminaires) using light emitting diodes (LEDs) have in recent years become somewhat practical and continue to penetrate the lighting market due to the increased luminous efficacy of commercially available LED components. LED lighting fixtures are desirable as they offer customers energy savings due to good luminous efficacy combined with the ability to precisely control light distribution patterns, which is of particular importance for certain lighting scenarios, such as outdoor environments, and open environments, such as parking garages and canopies. Electrical components for powering and controlling LED lighting fixtures are typically contained within an associated housing. During operation, heat is often produced by the electrical components that may be detrimental to the function of the lighting fixture.

### SUMMARY

Aspects and advantages of embodiments of the present disclosure will be set forth in part in the following description, or may be learned from the description, or may be learned through practice of the embodiments.

One example aspect of the present disclosure is directed to a lighting fixture that includes one or more drivers and a mounting surface. The lighting fixture can further include a clamping bracket for securing the one or more drivers to the mounting surface. The clamping bracket can include a body. The clamping bracket can further include a first arm and a second arm. The first arm and the second arm can each extend from the body. Furthermore, the first arm and the second arm can each be bent relative to the body when the one or more drivers are secured to the mounting surface via the clamping bracket.

Another example aspect of the present disclosure is directed to a lighting fixture. The lighting fixture can include one or more drivers and a mounting surface. The lighting fixture can further include a clamping bracket configured to secure the one or more drivers to the mounting surface. The clamping bracket can define a coordinate system that includes a lateral direction, a transverse direction, and a vertical direction. The clamping bracket can include a body. The clamping bracket can further include a sidewall extending from the body such that a portion of the sidewall contacts the one or more drivers. The clamping bracket can further include a first arm and a second arm. The first arm and the second arm can each extend from the body. Furthermore, the first arm and the second arm can each be bent relative to the body when the one or more drivers are secured to the mounting surface via the clamping bracket.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a rear perspective view of an example lighting fixture according to example embodiments of the present disclosure;

FIG. 2 depicts a side view of an example lighting fixture according to example embodiments of the present disclosure;

FIG. 3 depicts a front view of an example lighting fixture according to example embodiments of the present disclosure;

FIG. 4 depicts an example lighting fixture with a lower housing portion in an open position according to example embodiments of the present disclosure;

FIG. 5 depicts a perspective view of an example housing portion for supporting a driver of a lighting fixture according to example embodiments of the present disclosure;

FIG. 6 depicts a top view of a clamping bracket according to example embodiments of the present disclosure;

FIG. 7 depicts a side view of a clamping bracket according to example embodiments of the present disclosure;

FIG. 8 depicts another side view of a clamping bracket according to example embodiments of the present disclosure;

FIG. 9 depicts an intermediate portion of a clamping bracket in a first position according to example embodiments of the present disclosure;

FIG. 10 depicts an intermediate portion of a clamping bracket in a second position according to example embodiments of the present disclosure;

FIG. 11 depicts a top view of a clamping bracket according to example embodiments of the present disclosure;

FIG. 12 depicts a side view of a clamping bracket according to example embodiments of the present disclosure;

FIG. 13 depicts an intermediate portion of a clamping bracket in a first position according to example embodiments of the present disclosure; and

FIG. 14 depicts an intermediate portion of a clamping bracket in a second position according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to a clamping bracket configured to secure one or more drivers to a mounting surface. It should be appreciated, however, that the mounting surface can be associated with any suitable component of the lighting fixture. For instance, in some implementations, the mounting surface can be associated with a driver casing of the lighting fixture. The clamping bracket can define an orthogonal coordinate system comprising a vertical direction, a lateral direction, and a transverse direction. The clamping bracket can include an inner portion, an outer portion, and an intermediate portion extending between the inner portion and the outer portion.

In some implementations, the inner portion can include a body having a first end and a second end spaced apart from the first end. In addition, the body can define one or more apertures. In some implementations, the one or more apertures can be configured to accommodate one or more electrical wires associated with the one or more drivers. In addition, the one or more apertures can accommodate cable ties used to secure one or more electrical wires associated with the one or more drivers. In some implementations, the one or more apertures can be used to mount one or more components associated with the lighting fixture to the body of the clamping bracket. For instance, the one or more components can include one or more surge protection devices.

In some implementations, the inner portion can include a first sidewall and a second sidewall. The first sidewall and the second sidewall can each extend from the body. In particular, the first sidewall can extend from the first end of the body. Conversely, the second sidewall can extend from the second end of the body. In this manner, the first sidewall and the second sidewall can be spaced apart from one another.

In some implementations, the first sidewall and the second sidewall can each include a first post or projection and a second post or projection spaced apart from the first projection. In addition, the first sidewall and the second sidewall can each include a crossbar extending between the first projection and the second projection. It should be appreciated that the inner portion of the clamping bracket can extend between the first projection and the second projection.

In some implementations, the first projection and the second projection can be spaced apart from one another such that a distance defined therebetween corresponds to a width of the one or more drivers. In this manner, the first projection and the second projection can contact opposing sides of the one or more drivers when the one or more drivers are secured to the mounting surface via the clamping bracket.

In some implementations, the outer portion of the clamping bracket can include a first mounting tab and a second mounting tab. The first mounting tab and the second mounting tab can each define an aperture. The first mounting tab can be spaced apart from the second mounting tab. In this manner, the aperture defined by the first mounting tab can be spaced apart from the aperture defined by the second mounting tab. It should be appreciated that the aperture defined by the first mounting tab and the aperture defined by second mounting tab can be configured to accommodate a fastener used to secure the clamping bracket to the mounting surface.

In some implementations, the intermediate portion can include a first arm and a second arm. The first arm and the second arm can each extend between the inner portion of the clamping bracket and the outer portion of the clamping bracket. In particular, the first arm can extend from the body to the first mounting tab. Conversely, the second arm can extend from the body to the second mounting tab.

The intermediate portion of the clamping bracket can be movable between a first position and a second position. More specifically, the first arm and the second arm are each movable between the first position and the second position. The inner portion of the clamping bracket can contact the one or more drivers when the intermediate portion of the clamping bracket is in the first position. For example, the crossbar of the first sidewall can contact a top surface of the one or more drivers when the intermediate portion is in the first position. Additionally, the first projection and the second projection of the first sidewall and the second sidewall can each contact opposing sides of the one or more drivers. In this manner, the clamping bracket can restrict movement of the one or more drivers along both the vertical direction and the lateral direction.

In some implementations, the inner portion of the clamping bracket is more rigid (e.g., stiff) compared to the intermediate portion (e.g., first arm, second arm) of the clamping bracket. In this way, the inner portion can be less susceptible to flexion (e.g., bending) when the intermediate portion of the clamping bracket moves from the first position to the second position. In some implementations, the inner portion of the clamping bracket is more rigid compared to both the intermediate portion of the clamping bracket and the outer portion of the clamping bracket.

When the intermediate portion of the clamping bracket is in the first position, the outer portion of the clamping bracket is spaced apart from the mounting surface. More specifically, a gap is defined along the vertical direction between the first mounting tab and the mounting surface. In addition, a gap is defined along the vertical direction between the second mounting tab and the mounting surface.

As mentioned above, the first mounting tab and the second mounting tab can each define an aperture configured to accommodate a fastener used to secure the clamping bracket to the mounting surface. In particular, a first fastener extending through the aperture defined by the first mounting tab can be rotated to fasten (e.g., secure) the clamping bracket to the mounting surface at the first mounting tab. In addition, a second fastener extending through the aperture defined by the second mounting tab can be rotated to fasten (e.g., secure) the clamping bracket to the mounting surface at the second mounting tab.

When the clamping bracket is secured to the mounting surface via the first fastener and the second fastener, the intermediate portion of the clamping bracket is in the second position. In particular, the first arm and the second arm are each bent relative to the body of the clamping bracket. For instance, the first arm is bent towards the mounting surface to absorb a first force the first fastener exerts on the clamping bracket at the first mounting tab. In this manner, the first mounting tab can contact the mounting surface. Likewise, the second arm is bent towards the mounting surface to absorb a second force the second fastener exerts on the clamping bracket at the second mounting tab. In this manner, the second mounting tab can contact the mounting surface.

Movement of the intermediate portion of the clamping bracket from the first position to the second position to absorb the first force and second force exerted on the clamping bracket via the first fastener and second fastener, respectively, prevents flexion (e.g., bowing) of the inner portion of the clamping bracket. Furthermore, since the inner portion (e.g., body) of the clamping bracket is, as discussed above, more rigid (e.g., stiff) compared to the intermediate portion (e.g., first arm, second arm) of the clamping bracket, the inner portion of the clamping bracket is unaffected (that is, does not bend) by the first force and the second force that the first fastener and the second fastener, respectively, exert on the clamping bracket. Thus, the inner portion of the clamping bracket can remain pressed against the one or more drivers when the clamping bracket is secured to the mounting surface via the first fastener and the second fastener. More specifically, the inner portion of the clamping bracket can contact the one or more drivers at a central portion thereof to prevent the one or more drivers from tipping. In this manner, a greater surface area of the one or more drivers can contact the mounting surface and, as a result, heat transfer between the one or more drivers and the mounting surface can be improved.

The clamping bracket according to the present disclosure can provide numerous technical benefits. For instance, securing the one or more drivers to the driver casing via the clamping bracket can allow for the use of blind holes. In this manner, a seal between the driver casing and an external environment surrounding the driver casing can be improved, because the driver casing no longer requires holes that extend all the way through the driver housing.

As used herein, a “lighting fixture” refers to a device used to provide light or illumination using one or more light sources. In addition, the terms “first” and “second” may be used interchangeably to distinguish one component from another and are not intended to signify location or importance of the individual components.

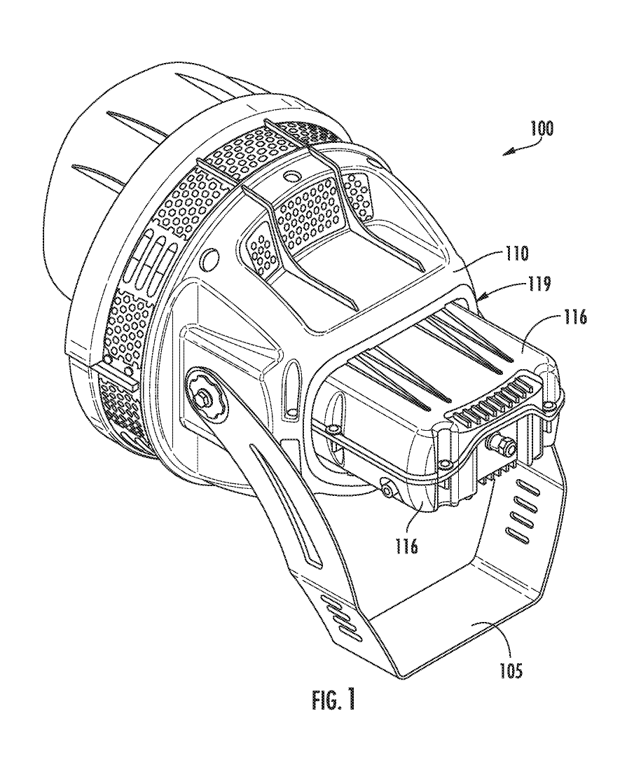

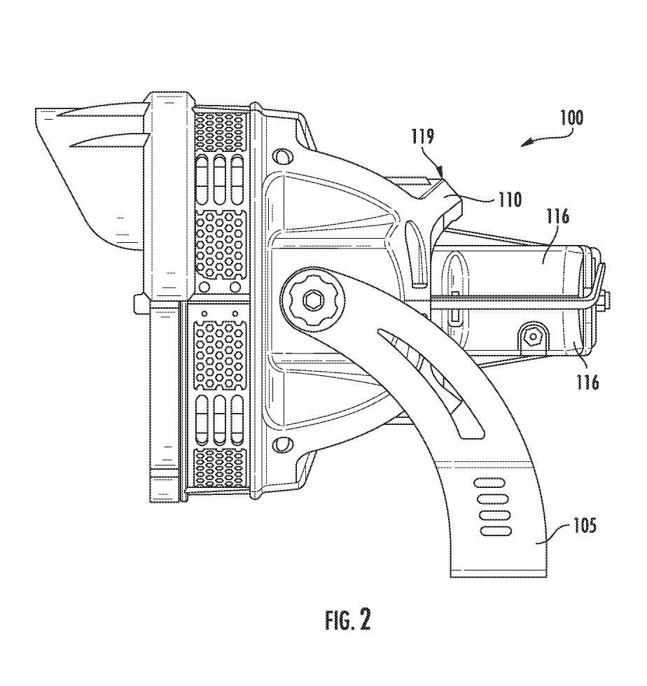

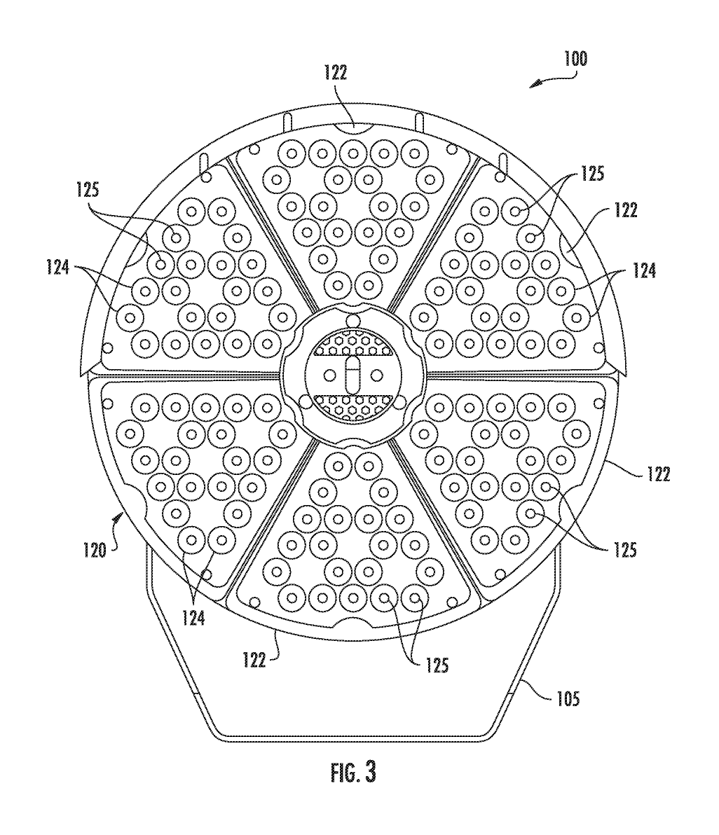

Referring now to the figures, FIGS. 1 through 3 depict a lighting fixture 100 according to an example embodiment of the present disclosure. As used herein, a “lighting fixture” or “luminaire” refers to a device used to provide light or illumination using one or more light sources. The lighting fixture 100 can be, for instance, an area or flood lighting fixture configured to provide lighting for a space, such as an athletic field, a stadium, etc. The lighting fixture 100 can be mounted to a pole, wall, or other structure using a plurality of different mounting options. For instance, the lighting fixture 100 can include a mounting yoke or bracket 105 for mounting to a horizontal arm. Alternatively, the lighting fixture 100 can be mounted, for instance, using a pole, wall, vertical tenon, or traditional arm mounting. Mounting options can also include use of a wall bracket, adjustable knuckle, outer diameter slip fit arm mount, rectangular arm, etc.

In some implementations, the lighting fixture 100 includes a housing 110 configured to contain and/or cover various components of the lighting fixture 100, such as electrical components, conductors, etc. The housing 110 can be made from a suitable material such as plastic, aluminum, die cast aluminum, stainless steel, galvanized steel, powder coated steel, or other material. In certain implementations, the housing 110 can be a plastic shell that covers internal components of the lighting fixture 100. It should be understood that the lighting fixture 100 may omit the housing 110 in certain implementations, e.g., such that the internal components of the lighting fixture 100 are enclosed within a plastic shell. In some implementations, the housing 110 can be in conductive thermal communication with electrical components and light sources (e.g., LED devices) associated with the lighting fixture 100. Thus, the housing 110 can act as a thermal heat sink for heat generated by the electrical components and light sources (e.g., LED devices) associated with the lighting fixture 100 by conducting heat away from heat generating sources within the housing 110 to the ambient atmosphere around the housing 110.

In some implementations, the lighting fixture 100 can include an LED system 120. More specifically, the LED system 120 can include a plurality of light engine modules 122. Thus, the LED system 120 can be a module LED system. In some implementations, each light engine module of the plurality of light engine modules 122 includes a plurality of LED devices 125 mounted on a printed circuit board (PCB) or LED board. Each LED device of the plurality of LED devices 125 can be configured to emit light as a result of movement of electrons through a semiconductor material. It should be appreciated that each LED device of the plurality of LED devices 125 can be of any suitable size, color, color temperature, etc. for the desired light applications. For instance, one or more LED devices of the plurality of LED devices 125 can have a color temperature of about 3000K, about 4000K, about 5000K or any other suitable color temperature.

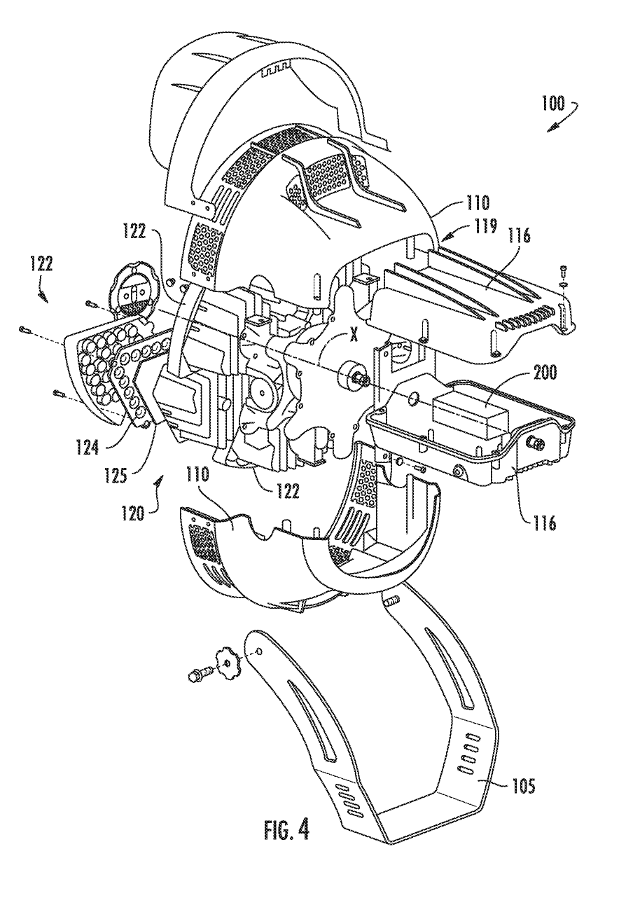

Referring now to FIG. 4, an optic 124 (e.g., a lens) can be positioned over each LED device of the plurality of LED devices 125. The optics 124 and/or arrangement of the LED devices 125 can be configured to provide a variety of different light distributions, such as a type I distribution, type II distribution, type III distribution, type IV distribution, type V distribution (e.g., round, square, round wide, etc.), other light distribution, or combination of light distributions. In some implementations, the optics 124 and/or arrangement of the LED devices 125 can be configured to provide flood optics, such as a 2×2 beam pattern, a 3×3 beam pattern, a 4×4 beam pattern, a 5×5 beam pattern, and a 6×6 beam pattern. The plurality of LED devices 125 on each of the modules 122 can have a respective light distribution, in certain exemplary embodiments. The optics 124 can be connected or formed together on a plate, e.g., such that the optics 124 are formed from one piece of material.

In some implementations, the lighting fixture 100 can include one or more drivers 200 (only one shown) configured to convert AC power to DC power. Additionally and/or alternatively, the one or more drivers 200 can provide constant current and/or DC power to one or more component(s) of the light fixture 100, such as a light engine modules 122. In this way, the light engine modules 122 can illuminate one or more LED devices 125 when energized by the one or more drivers 200. In some implementations, the one or more driver s200 can be a dimmable driver. Example driver circuits include the PLED series drivers manufactured by Thomas Research Products. Example driver circuits are also illustrated in U.S. Patent Application Publication No. 2015/0351205, which is incorporated herein by reference.

In some implementations, the housing 110 of the lighting fixture 100 encloses or contains the one or more drivers 200. For instance, the one or more drivers 200 can be positioned within and/or attached to a driver casing 116 positioned at a rear portion 119 of the housing 110. As shown, the driver casing 116 can be a two-piece enclosure, and each half of the driver casing 116 can enclose or contain the one or more drivers 200.

In some implementations, the driver casing 116 can be configured to support the one or more drivers 200. For instance, the one or more drivers 200 can be attached to the driver casing 116 via a suitable attachment mechanism (e.g., fastener, screw, bolt, mounting boss, docketing sleeve, hole, male/female mechanism, etc.).

According to example embodiments of the present disclosure, the lighting fixture 100 can include a means for securing the one or more drivers 200 to a mounting surface to decrease thermal resistance between the one or more drivers 200 and the mounting surface. For instance, in some implementations, the mounting surface can correspond to an internal surface 118 of the driver casing 116. In some embodiments, the means can include a clamping bracket used to secure the one or more drivers 200 to the mounting surface.

Example aspects of the present disclosure are discussed with light fixture 100 for purposes of illustration and discussion. However, those of ordinary skill in the art, using the disclosure provided herein, will understand that other suitable lighting fixture can be used without deviating from the scope of the present disclosure.

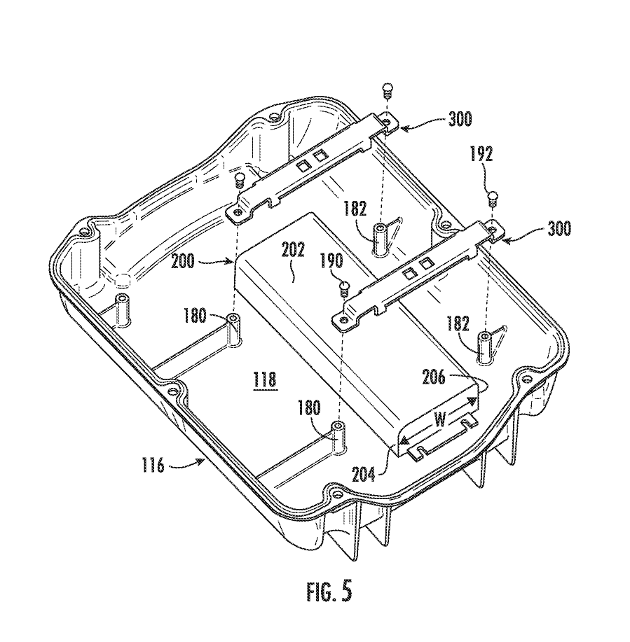

Referring now to FIGS. 5 through 10, an example embodiment of a clamping bracket 300 is provided according to example embodiments of the present disclosure. As shown, the clamping bracket 300 defines an orthogonal coordinate system that includes a vertical direction V, a lateral direction L, and a transverse direction T. The clamping bracket 300 includes an inner portion 310, an outer portion 320, and an intermediate portion 330 extending between the inner portion 310 and the outer portion 320.

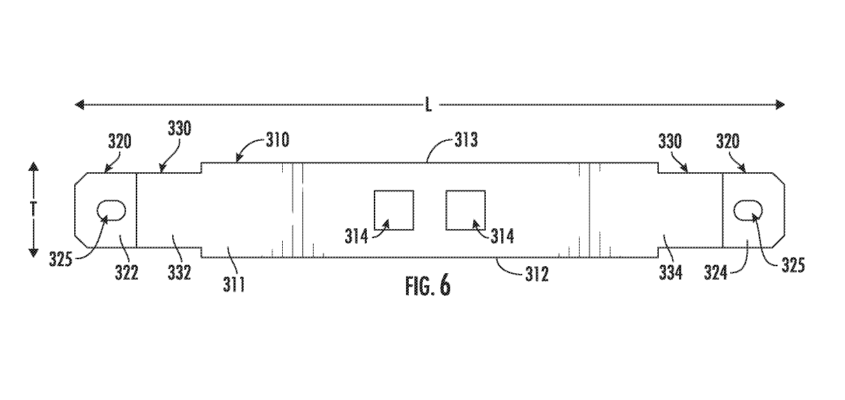

In some implementations, the inner portion 310 can include a body 311 having a first end 312 and a second end 313 spaced apart from the first end 312 along the transverse direction T. In addition, the body 311 can define one or more apertures 314. Although the body 311 depicted in FIG. 6 defines two apertures 314, it should be appreciated that the body 311 can define more or fewer apertures. As will be discussed below in more detail, the one or more apertures 314 can be configured to accommodate one or more components associated with the light fixture 100 (FIG. 1).

In some implementations, the one or more apertures 314 can be configured to accommodate one or more electrical wires associated with the one or more drivers 200. In addition, the one or more apertures 314 can accommodate cable ties used to secure one or more electrical wires associated with the one or more drivers 200. In some implementations, the one or more apertures 314 can be used to mount one or more components associated with the lighting fixture 100 (FIG. 1) to the body 311 of the clamping bracket 300. For instance, the one or more components can include one or more surge protection devices.

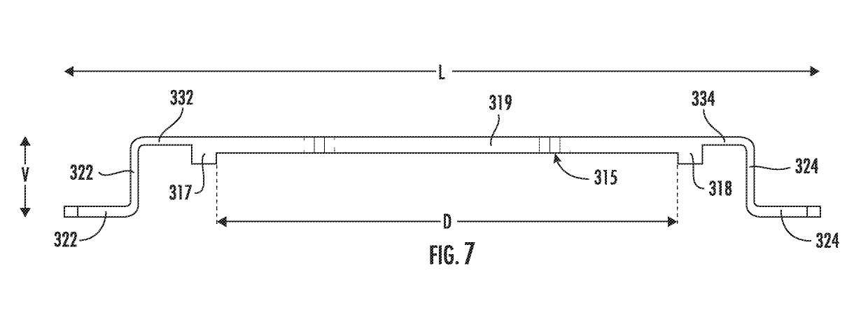

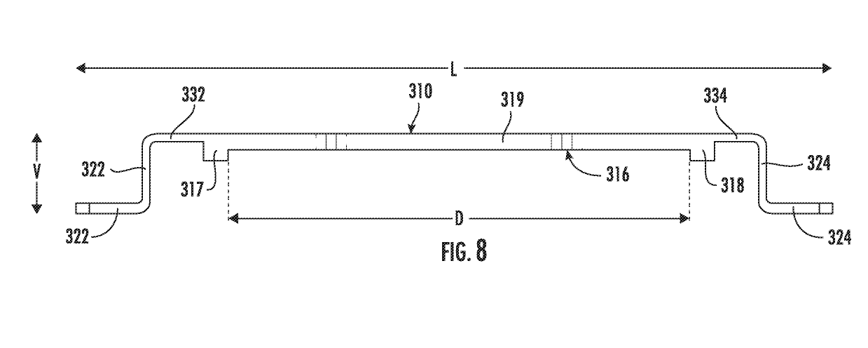

In some implementations, the inner portion 310 can include a first sidewall 315 (FIG. 7) and a second sidewall 316 (FIG. 8). The first sidewall 315 and the second sidewall 316 can each extend from the body 311 along the vertical direction V. In particular, the first sidewall 315 can extend from the first end 312 of the body 311. Conversely, the second sidewall 316 can extend from the second end 313 of the body 311. In this manner, the first sidewall 315 and the second sidewall 316 can be spaced apart from one another along the transverse direction T.

In some implementations, the first sidewall 315 and the second sidewall 316 can each include a first post or projection 317 and a second post or projection 318 spaced apart from the first projection 317 along the lateral direction L. In addition, the first sidewall 315 and the second sidewall 316 can each include a crossbar 319 extending between the first projection 317 and the second projection 318 along the lateral direction L. It should be appreciated that the inner portion 310 of the clamping bracket 300 can extend along the lateral direction L between the first projection 317 and the second projection 318.

In some implementations, the first projection 317 and the second projection 318 can be spaced apart from one another along the lateral direction L such that a distance D defined therebetween corresponds to a width W of the one or more drivers 200. In this manner, the first projection 317 and the second projection 318 can contact sides 204, 206 (FIG. 5) of the one or more drivers 200, respectively, when the one or more drivers 200 are secured to the driver casing 116 via the clamping bracket 300.

In some implementations, the outer portion 320 of the clamping bracket 300 can include a first mounting tab 322 and a second mounting tab 324. As shown, the first mounting tab 322 and the second mounting tab 324 can each define an aperture 325. The first mounting tab 322 can be spaced apart from the second mounting tab 324 along the lateral direction L. In this manner, the aperture 325 defined by the first mounting tab 322 can be spaced apart from the aperture 325 defined by the second mounting tab 324 along the lateral direction L. It should be appreciated that the aperture 325 defined by the first mounting tab 322 and the aperture 325 defined by second mounting tab 324 can each be configured to accommodate first and second fasteners 190, 192 used to secure the clamping bracket 300 to the driver casing 116.

In some implementations, the intermediate portion 330 can include a first arm 332 and a second arm 334. As shown, the first arm 332 and the second arm 334 can each extend between the inner portion 310 of the clamping bracket 300 and the outer portion 320 of the clamping bracket 300. In particular, the first arm 332 can extend from the body 311 to the first mounting tab 322. Conversely, the second arm 334 can extend from the body 311 to the second mounting tab 324.

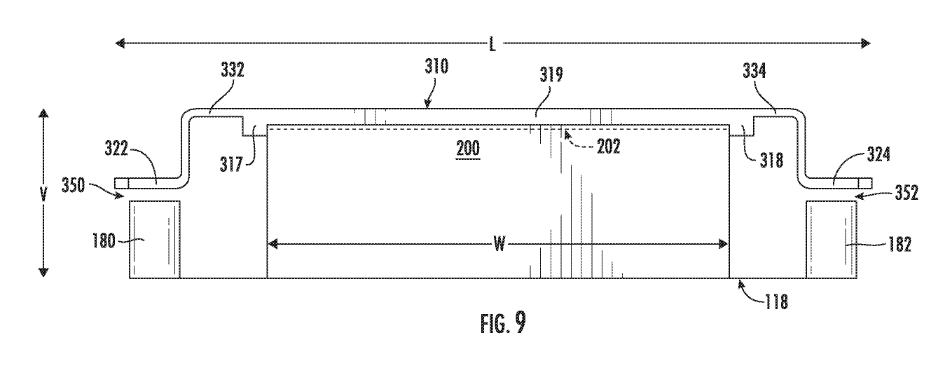

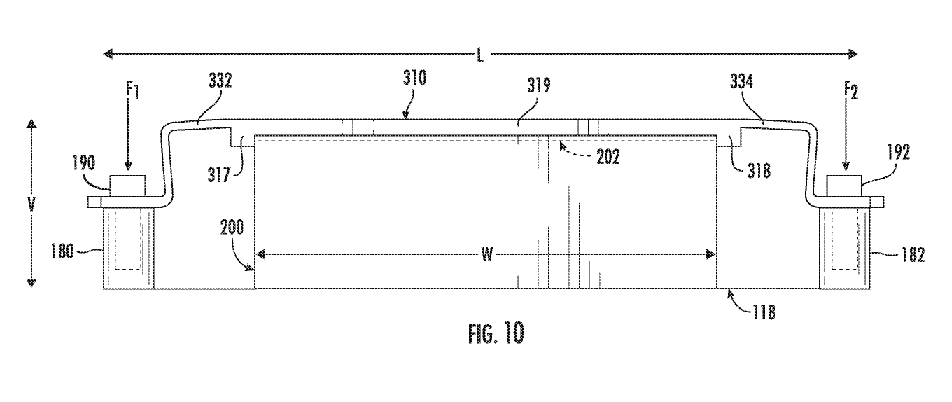

As shown in FIGS. 9 and 10, the intermediate portion 330 of the clamping bracket 300 is movable between a first position (FIG. 9) and a second position (FIG. 10). More specifically, the first arm 332 and the second arm 334 are each movable between the first position and the second position. As shown, the inner portion 310 of the clamping bracket 300 contacts the one or more drivers 200 when the intermediate portion 330 (e.g., first arm 322 and second arm 324) of the clamping bracket 330 is in the first position (FIG. 9). More specifically, the crossbar 316 of the first sidewall contacts a top surface 202 of the one or more drivers 200 when the intermediate portion 330 is in the first position. Additionally, the first projection 317 and the second projection 318 of the first sidewall 315 and the second sidewall 316 each contact opposing sides 204, 206 (FIG. 5) of the one or more drivers 200, respectively. In this manner, the clamping bracket 300 can restrict movement of the one or more drivers 200 along both the vertical direction V and the lateral direction L.

In implementations in which the clamping bracket 300 is used to secure two or more drivers 200 to the driver casing 116, the two or more drivers 200 can be positioned between the first projection 317 and the second projection 318 such that the first projection 317 contacts the side 204 of a first driver and the second projection 318 contacts the side 206 of a second driver that is different than the first driver. Alternatively, the first sidewall 315 and the second sidewall 316 can each include multiple projections spaced apart from one another along the lateral direction L. In this manner, each of the two or more drivers 200 can positioned between adjacent projections.

In some implementations, the first projection 317 and the second projection 318 of the first sidewall 315 and the second sidewall 316 may not contact the opposing sides 204, 206 of the one or more drivers 200, respectively, when the intermediate portion 330 of the clamping bracket 300 is in the first position (FIG. 9). For instance, the first projection 317 and the second projection 318 can be spaced apart from one other along the lateral direction L such that the distance D defined therebetween is greater than the width W of the one or more drivers 200 by a predetermined amount. In this manner, the one or more drivers 200 can move along the lateral direction L by the predetermined amount when the one or more drivers 200 are secured to the driver casing 116 via the clamping bracket 300.

In some implementations, the inner portion 310 of the clamping bracket 300 is more rigid (e.g., stiff) compared to the intermediate portion 330 of the clamping bracket 300. More specifically, the body 311 of the clamping bracket is more rigid compared to the first arm 332 and the second arm 334. In this way, the inner portion 310 can be less susceptible to flexion (e.g., bending) when the first arm 332 and the second arm 334 move from the first position (FIG. 9) to the second position (FIG. 10). In some implementations, the inner portion 310 of the clamping bracket 300 is more rigid compared to both the intermediate portion 330 (e.g., first arm 332, second arm 334) of the clamping bracket 300 and the outer portion 320 (e.g., first mounting tab 322, second mounting tab 324) of the clamping bracket 300.

As shown in FIG. 9, the outer portion 320 of the clamping bracket 300 is spaced apart from the driver casing 116 when the intermediate portion 330 of the clamping bracket 300 is in the first position. More specifically, a gap 350 is defined along the vertical direction V between the first mounting tab 322 and a first mounting boss 180 extending from an interior surface 118 of the driver casing 116. In addition, a gap 352 is defined along the vertical direction V between the second mounting tab 324 and a second mounting boss 182 extending form the interior surface 118 of the driver casing 116.

The intermediate portion 330 of the clamping bracket 300 is in the second position (FIG. 10) when the clamping bracket 300 is secured to the driver casing 116 (FIG. 5) via the first fastener 190 and the second fastener 192. In particular, the first arm 332 and the second arm 334 are each bent relative to the body 311 of the clamping bracket 300. As shown, the first arm 332 is bent towards the interior surface 118 of the driver casing 116 to absorb a first force F₁ the first fastener 190 exerts on the clamping bracket 300 to fasten (e.g., secure) the clamping bracket 300 to the first mounting boss 180 at the first mounting tab 322. In this manner, the first mounting tab 322 can contact first mounting boss 180 without causing the body 311 of the clamping bracket 300 to flex (e.g., bend) due to the first fastener 190 exerting the first force F₁ on the clamping bracket 300. Likewise, the second arm 334 is bent towards the interior surface 118 of the driver casing 116 to absorb a second force F₂ the second fastener 192 exerts on the clamping bracket 300 to fasten the clamping bracket 300 to the second mounting boss 182 at the second mounting tab 324. In this manner, the second mounting tab 324 can contact the second mounting boss 182 without causing the body 311 of the clamping bracket 300 to flex (e.g. bend) due to the second fastener 192 exerting the second force F₂ on the clamping bracket 300.

It should be understood that movement of the intermediate portion 330 of the clamping bracket 300 along the vertical direction V from the first position (FIG. 9) to the second position (FIG. 10) to absorb the first force F₁ and second force F₂ exerted on the clamping bracket 300 via the first fastener 190 and second fastener 192, respectively, prevents flexion (e.g., bowing) of the inner portion 310 of the clamping bracket 300. Furthermore, since the inner portion 310 of the clamping bracket 300 is, as discussed above, more rigid (e.g., stiff) compared to the intermediate portion 330 of the clamping bracket 300, the inner portion 310 of the clamping bracket 300 can be unaffected (that is, does not bend) by the first force F₁ and the second force F₂ that the first fastener 190 and the second fastener 192, respectively, exert on the clamping bracket 300. Thus, the inner portion 310 of the clamping bracket 300 can remain pressed against the one or more drivers 200 when the clamping bracket 300 is secured to the driver casing 116 (FIG. 5) via the first fastener 190 and the second fastener 192. More specifically, the inner portion of the clamping bracket 300 can contact the one or more drivers at a central portion thereof to prevent the one or more drivers from tipping. In this manner, a greater surface area of the one or more drivers 200 can contact the interior surface 118 of the driver casing 116 and, as a result, heat transfer between the driver casing 116 and the one or more drivers 200 can be improved.

In some implementations, the intermediate section 330 of the clamping bracket 300 can return to the first position (FIG. 9) each time the clamping bracket 300 is decoupled from the driver casing 116. More specifically, the first arm 332 can return to the first position when the fastener 190 is rotated such that the clamping bracket 300 is no longer secured to the first mounting boss 180 at the first mounting tab 322. Likewise, the second arm 334 can return to the first position when the fastener 192 is rotated such that the clamping bracket 300 is no longer secured to the second mounting boss 182 at the second mounting tab 324.

In some implementations, the intermediate section 330 can remain in the second position (FIG. 10) even after the clamping bracket 300 is no longer secured to the driver casing 116 via fasteners 190, 192. More specifically, the first force F₁ being applied to the clamping bracket 300 via rotation of the fasteners 190 can stress the first arm 332 beyond its elastic limit. Likewise, the second force F₂ being applied to the clamping bracket 300 via rotation of the fastener 192 can stress the second arm 334 beyond its elastic limit. Accordingly, in such implementations, the first arm 332 and the second arm 334 can remain in the second position (FIG. 10) even after the fasteners 190, 192 are loosened.

It should be appreciated that the clamping bracket 300 can be formed from any suitable material. For instance, in some implementations the clamping bracket 300 can be formed from aluminum. More specifically, the clamping bracket 300 can be formed from 5052-H32 aluminum. In alternative implementations, the clamping bracket 300 can be formed from steel.

It should also be appreciated that the clamping bracket 300 can be used to secure the one or more drivers 200 to any suitable mounting surface associated with the lighting fixture 100. For instance, in some implementations, the mounting surface can be associated with a component (e.g., bracket) of the lighting fixture 100 that is separate from the driver casing 116. Furthermore, it should be appreciated that any suitable number of clamping brackets 300 can be used to secure the one or more drivers 200 to the mounting surface. For instance, in some implementations two or more clamping brackets 300 can be used to secure the one or more drivers 200 to the driver casing 116.

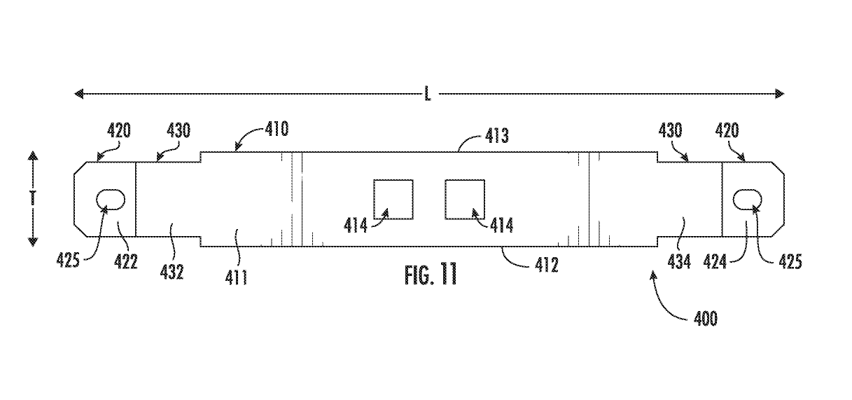

Referring now to FIGS. 11 through 14, another example embodiment of a clamping bracket 400 is provided according to the present disclosure. As shown, the clamping bracket 400 defines an orthogonal coordinate system that includes a vertical direction V, a lateral direction L, and a transverse direction T. In some implementations, the clamping bracket 400 includes an inner portion 410, an outer portion 420, and an intermediate portion 430 extending between the inner portion 410 and the outer portion 420. The outer portion 420 can, in some implementations, be spaced apart from the inner portion 410 along the vertical direction V.

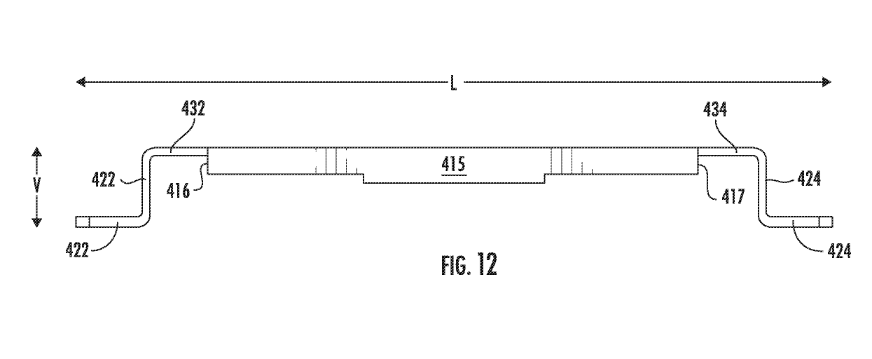

In some implementations, the inner portion 410 can include a body 411 having a first end 412 and a second end 413 spaced apart from the first end 412 along the transverse direction T. In addition, the body 411 can define one or more apertures 414. Although the body 411 depicted in FIG. 12 defines two apertures 414, it should be appreciated that the body 411 can define more or fewer apertures. As will be discussed below in more detail, the one or more apertures 414 can be configured to accommodate one or more components associated with the light fixture 100 (FIG. 1).

In some implementations, the one or more apertures 414 can be configured to accommodate one or more electrical wires associated with the one or more drivers 200. In addition, the one or more apertures 414 can accommodate cable ties used to secure one or more electrical wires associated with the one or more drivers 200. In some implementations, the one or more apertures 414 can be used to mount one or more components associated with the lighting fixture 100 to the body 411 of the clamping bracket 400. For instance, the one or more components can include one or more surge protection devices.

In some implementations, the inner portion 410 can include a sidewall 415. As shown, the sidewall 415 can extend from the body 411 along the vertical direction V. In particular, the sidewall 415 can extend from the first end 412 of the body 411. The sidewall 415 can include a first end 416 and a second end 417. As shown, the first end 416 can be spaced apart from the second end 417 along the lateral direction L. In some implementations, the inner portion 410 of the clamping bracket 400 can extend along the lateral direction L between the first end 416 of the sidewall 415 and the second end 417 of the sidewall 415.

When the clamping bracket 400 is secured (e.g., fastened) to the driver casing 116, a portion of the sidewall 415 can contact the top surface 202 of the one or more drivers 200. In some implementations, the one or more drivers 200 can include a plurality of ribs 210 extending from the top surface 202 thereof and spaced apart from one another such that a recess 220 is defined between adjacent ribs 210. As shown, the portion of the sidewall 415 can contact the top surface 202 of the one or more drivers 200 such that the portion of the sidewall 415 is positioned within the recess 220 defined between adjacent ribs 210. In this manner, the clamping bracket 400 can restrict or limit movement of the one or more drivers 200 along the vertical direction V.

In some implementations, the clamping bracket 400 can include a second sidewall (not shown) extending from the body 411. For instance, the second sidewall can be substantially similar to the sidewall 415 discussed above. In this manner, a portion of the second sidewall can contact the top surface of the one or more drivers 200 such that the portion of the second sidewall is disposed within the recess 220 defined between adjacent ribs 210

In some implementations, the outer portion 420 of the clamping bracket 400 can include a first mounting tab 422 and a second mounting tab 424. As shown, the first mounting tab 422 and the second mounting tab 424 can each define an aperture 425. Furthermore, the first mounting tab 422 can be spaced apart from the second mounting tab 424 along the lateral direction L. In this manner, the aperture 425 defined by the first mounting tab 422 can be spaced apart from the aperture 425 defined by the second mounting tab 424. It should be appreciated that the aperture 425 defined by the first mounting tab 422 and the aperture 425 defined by the second mounting tab 424 can be configured to accommodate fasteners 190, 192 used to secure the clamping bracket 400 to the driver casing 116 (FIG. 5).

In some implementations, the intermediate portion 430 can include a first arm 432 and a second arm 434. As shown, the first arm 432 and the second arm 434 can each extend between the inner portion 410 of the clamping bracket 400 and the outer portion 420 of the clamping bracket 400. In particular, the first arm 432 can extend between the first mounting tab 422 and the first end 416 of the sidewall 415. Conversely, the second arm 434 can extend between the second mounting tab 424 and the second end 417 of the sidewall 415.

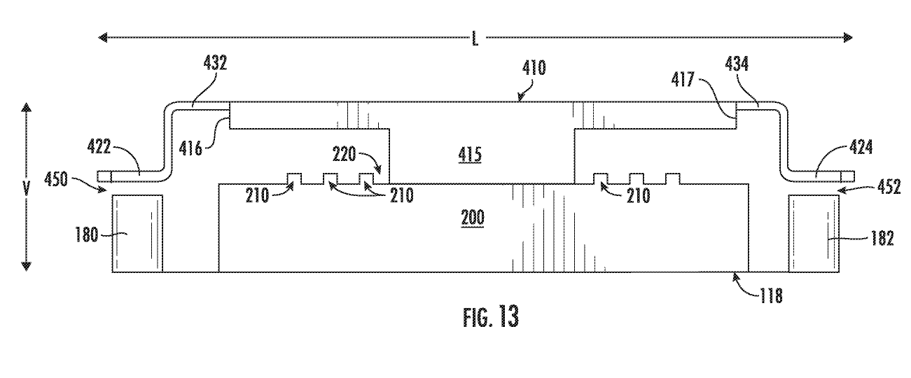

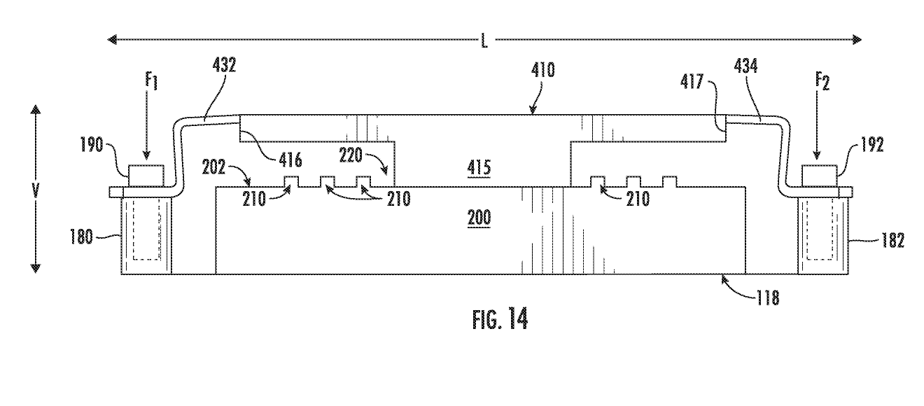

As shown in FIGS. 13 and 14, the intermediate portion 430 of the clamping bracket 400 is movable between a first position (FIG. 13) and a second position (FIG. 14). More specifically, the first arm 432 and the second arm 434 are each movable along the vertical direction V between the first position and the second position. As shown, the inner portion 410 of the clamping bracket 400 contacts the one or more drivers 200 when the intermediate portion 430 of the clamping bracket 400 is in the first position. More specifically, the body 411 of the inner portion 410 can contact the top surface 202 of the one or more drivers 200 when the intermediate portion 430 is in the first position.

In some implementations, the inner portion 410 of the clamping bracket 400 is more rigid (e.g., stiff) relative to the intermediate portion 430 of the clamping bracket 400. In this way, the inner portion 410 can be less susceptible to flexion (e.g. bending) when the intermediate portion 430 of the clamping bracket 400 moves from the first position (FIG. 13) to the second position (FIG. 14). In some implementations, the inner portion 410 of the clamping bracket 400 is more rigid relative to both the intermediate portion 430 of the clamping bracket 400 and the outer portion 420 of the clamping bracket 400.

As shown in FIG. 13, the outer portion 420 of the clamping bracket 400 is spaced apart from the driver casing 116 when the intermediate portion 430 of the clamping bracket 400 is in the first position. More specifically, a gap 450 is defined along the vertical direction V between the first mounting tab 422 and the first mounting boss 180 extending from the interior surface 118 of the driver casing 116. In addition, a gap 452 is defined along the vertical direction V between the second mounting tab 424 and the second mounting boss 182 extending from the interior surface 118 of the driver casing 116.

The intermediate portion 430 of the clamping bracket 400 is in the second position (FIG. 14) when the clamping bracket 400 is secured to the driver casing 116 (FIG. 5) via the first fastener 190 and the second fastener 192. In particular, the first arm 432 and the second arm 434 are each bent relative to the body 411 of the clamping bracket 300. As shown, the first arm 432 is bent towards the interior surface 118 of the driver casing 116 to absorb a first force F₁ the first fastener 190 exerts on the clamping bracket 400 to fasten (e.g., secure) the clamping bracket 400 to the first mounting boss 180 at the first mounting tab 422. In this manner, the first mounting tab 422 can contact first mounting boss 180 without causing the body 411 of the clamping bracket 400 to flex (e.g., bend) due to the first fastener 190 exerting the first force F₁ on the clamping bracket 400. Likewise, the second arm 434 is bent towards the interior surface 118 of the driver casing 116 to absorb a second force F₂ the second fastener 192 exerts on the clamping bracket 400 to fasten the clamping bracket 400 to the second mounting boss 182 at the second mounting tab 424. In this manner, the second mounting tab 424 can contact the second mounting boss 182 without causing the body 411 of the clamping bracket 400 to flex (e.g. bend) due to the second fastener 192 exerting the second force F₂ on the clamping bracket 400.

It should be understood that movement of the intermediate portion 430 of the clamping bracket 400 along the vertical direction V from the first position (FIG. 13) to the second position (FIG. 14) to absorb the first force F₁ and second force F₂ exerted on the clamping bracket 400 via the first fasteners 190 and the second fastener 192, respectively, prevents flexion (e.g., bowing) of the inner portion 410 of the clamping bracket 400. Furthermore, since the inner portion 410 of the clamping bracket 400 is, as discussed above, more rigid (e.g., stiff) compared to the intermediate portion 430 of the clamping bracket 400, the inner portion 410 of the clamping bracket 400 can be unaffected (that is, does not bend) by the first force F₁ and the second force F₂ that the first fastener 190 and the second fastener 192, respectively, exert on the clamping bracket 400. Thus, the inner portion 410 of the clamping bracket 400 can remain pressed against the one or more drivers 200 when the clamping bracket 400 is secured to the driver casing 116 (FIG. 5) via the first fastener 190 and the second fastener 192. More specifically, the inner portion of the clamping bracket 400 can contact the one or more drivers at a central portion thereof to prevent the one or more drivers from tipping. In this manner, a greater surface area of the one or more drivers 200 can contact the interior surface 118 of the driver casing 116 and, as a result, heat transfer between the driver casing 116 and the one or more drivers 200 can be improved.

In some implementations, the intermediate section 430 of the clamping bracket 400 can return to the first position (FIG. 13) each time the clamping bracket 400 is decoupled from the driver casing 116. More specifically, the first arm 432 can return to the first position when the fastener 190 is rotated such that the first mounting tab 422 is no longer secured to the first mounting boss 180. Likewise, the second arm 434 can return to the first position when the fastener 192 is rotated such that the second mounting tab 424 is no longer secured to the second mounting boss 182.

In some implementations, the intermediate section 430 can remain in the second position (FIG. 14) even after the clamping bracket 400 is no longer secured to the driver casing 116 via fasteners 190, 192. More specifically, a single occurrence of the first force F₁ being applied to the clamping bracket 400 via rotation of the fasteners 190 can stress the first arm 432 beyond its elastic limit. Likewise, a single occurrence of the second force F₂ being applied to the clamping bracket 400 via rotation of the fastener 192 can stress the second arm 434 beyond its elastic limit. Accordingly, in such implementations, the first arm 432 and the second arm 434 can remain in the second position (FIG. 14) even after the fasteners 190, 192 are loosened.

In some implementations, the clamping bracket 400 can be formed from aluminum. More specifically, the clamping bracket 400 can be formed from 5052-H32 aluminum. It should be appreciated however that the clamping bracket 400 can be formed from any suitable material. For instance, the clamping bracket 400 can be formed from steel.

Although securing the clamping bracket 300, 400 has been discussed with reference to mounting bosses 180 extending from an interior surface 118 of the driver casing 116, it should be appreciated that the clamping bracket 300, 400 can be secured to the driver casing 116 via any suitable method. For instance, the clamping brackets 300, 400 can be secured to the driver casing 116 via one or more fasteners extending through apertures 325, 425 of the clamping bracket 300, 400 and one or more clearance holes defined in the driver casing 116.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A lighting fixture, comprising:
one or more drivers;
a mounting surface; and
a clamping bracket configured to secure the one or more drivers to the mounting surface, the clamping bracket defining a coordinate system comprising a lateral direction, a transverse direction and a vertical direction, the clamping bracket comprising:
a body;
a first arm extending from the body; and
a second arm extending from the body,
wherein when the one or more drivers are secured to the mounting surface via the clamping bracket, the first arm and the second arm are each bent relative to the body.

2. The lighting fixture of claim 1, wherein the mounting surface is associated with a driver casing configured to accommodate the one or more drivers.

3. The lighting fixture of claim 1, wherein the clamping bracket further comprises:
a first sidewall extending from the body; and
a second sidewall extending from the body, the second sidewall spaced apart from the first sidewall along the transverse direction.

4. The lighting fixture of claim 3, wherein the first sidewall and the second sidewall each comprise:
a first projection;
a second projection spaced apart from the first projection along the lateral direction; and
a crossbar extending along the lateral direction between the first projection and the second projection.

5. The lighting fixture of claim 4, wherein a distance between the first projection and the second projection corresponds to a width of the one or more drivers.

6. The lighting fixture of claim 4, wherein when the one or more drivers are secured to the mounting surface via the clamping bracket, the first projection and the second projection contact opposing sides of the one or more drivers.

7. The lighting fixture of claim 1, wherein the first arm and the second arm are movable along the vertical direction between a first position and a second position.

8. The lighting fixture of claim 7, wherein the clamping bracket further comprises:
a first mounting tab extending from the first arm; and
a second mounting tab extending from the second arm.

9. The lighting fixture of claim 8, wherein when the first arm and the second arm are in the first position:
a first gap is defined between the first mounting tab and the mounting surface; and
a second gap is defined between the second mounting tab and the mounting surface.

10. The lighting fixture of claim 8, wherein when the first arm and the second arm are in the second position:
the first mounting tab contacts the mounting surface such that the first arm is bent relative to the body; and
the second mounting tab contacts the mounting surface such that the second arm is bent relative to the body.

11. The lighting fixture of claim 8, wherein:
the first mounting tab defines a first aperture; and
the second mounting tab defines a second aperture.

12. The lighting fixture of claim 11, wherein the clamping bracket is secured to the mounting surface via a first fastener and a second fastener, the first fastener extending through the first aperture defined by the first mounting tab, the second mounting tab extending through the second aperture defined by the second mounting tab.

13. The lighting fixture of claim 12, wherein the clamping bracket is formed from aluminum.

14. The lighting fixture claim 1, wherein the body defines one or more apertures configured to accommodate one or more electrical wires associated with the one or more drivers.

15. The lighting fixture of claim 1, wherein the clamping bracket further comprises:
one or more sidewalls extending from the body such that a portion of the one or more sidewalls contacts the one or more drivers.

16. The lighting fixture of claim 15, wherein the portion of the sidewall is positioned within a recess defined by the one or more drivers.

17. A lighting fixture, comprising:
one or more drivers;
a mounting surface; and
a clamping bracket configured to secure the one or more drivers to the mounting surface, the clamping bracket defining a coordinate system comprising a lateral direction, a transverse direction and a vertical direction, the clamping bracket comprising:
a body;
a sidewall extending from the body such that a portion of the sidewall contacts the one or more drivers;
a first arm extending from the body; and
a second arm extending from the body,
wherein when the one or more drivers are secured to the mounting surface via the clamping bracket, the first arm and the second arm are each bent relative to the body.

18. The lighting fixture of claim 17, wherein the portion of the sidewall is positioned within a recess defined, at least in part, by the one or more drivers.

19. The lighting fixture of claim 17, wherein the clamping bracket further comprises:
a first mounting tab extending from the first arm, the first mounting tab defining a first aperture; and
a second mounting tab extending from the second arm, the second mounting tab defining a second aperture.

20. The lighting fixture of claim 17, wherein the mounting surface is associated with a driver casing of the lighting fixture.
